(19) United States
(12) Patent Application Publication
(10) Pub. No.: US 2026/0211082 A1
(43) Pub. Date: Jul. 23, 2026

(54) OPTICAL DETECTION COUNTERMEASURE

(71) Applicant: Torrey Pines Logic, Inc., San Diego, CA (US)

(72) Inventor: Leo Volfson, San Diego, CA (US)

(21) Appl. No.: 19/451,357

(22) Filed: Jan. 16, 2026

Related U.S. Application Data
(60) Provisional application No. 63/746,750, filed on Jan. 17, 2025.

(51) Int. Cl. G01S 7/48; G01S 7/4865; G01S 7/51; G01S 17/10

(52) U.S. Cl. CPC G01S 7/4804; G01S 7/4865; G01S 7/51; G01S 17/10

(57) ABSTRACT

An optical device includes an optical detector for detecting a light beam focused on an optical target coupled to the optical device, the light beam encoding an optical signature. The optical device includes a processor for decoding the optical signature of the light beam to generate a decoded optical signature. The optical device includes an optical aperture cover actuator controlling a movement of an optical aperture cover for closure of an optical aperture of the optical target.

### CROSS REFERENCE TO RELATED APPLICATION

This application claims priority under 35 U.S.C. § 119 to U.S. Application No. 63/746,750, filed on Jan. 17, 2025, the contents of which is hereby incorporated by reference.

### TECHNICAL FIELD

The present disclosure relates to optical imaging. More particularly, implementations of the present disclosure are directed to a system providing an optical detection countermeasure.

### BACKGROUND

Range finders are widely used in various applications including military, automotive, and industrial sectors. These systems utilize light waves, typically in the form of lasers, to measure the distance to a target by calculating the time it takes for the light to travel to the target and back. The imaged targets typically have limited countermeasures designed to deceive or disrupt the operation of the range finders. Some countermeasures include laser jamming involving the use of high-intensity light sources to overwhelm the range finder's sensor, rendering it unable to accurately detect the reflected signal from the target. Other countermeasures include laser spoofing by sending false signals to the range finder, causing it to miscalculate the distance to the target. Other countermeasures such as fog, smoke, and dust can scatter the laser beam, reducing the accuracy of the range finder.

### SUMMARY

The present disclosure generally describes an optical imaging system. More particularly, implementations of the present disclosure are directed to a system providing an optical detection countermeasure.

In an implementation, an optical device includes: an optical detector for detecting an incoming light beam focused on an optical target coupled to the optical device, the light beam encoding an optical signature; a processor for decoding the optical signature of the incoming or detected light beam to generate a decoded optical signature; and an optical aperture cover actuator controlling a movement of an optical aperture cover for closure of an optical aperture of the optical target.

In another implementation, a computer-implemented method detecting a light targeting event comprising identification of a light beam focused on an optical target, the light beam encoding an optical signature; decoding the optical signature to generate a decoded optical signature; and generating a trigger for controlling a movement of an optical aperture cover for closure of an optical aperture of the optical target.

The described subject matter can be implemented using a computer-implemented method; a non-transitory, computer-readable medium storing computer-readable instructions to perform the computer-implemented method; and a computer-implemented system comprising one or more computer memory devices interoperably coupled with one or more computers and having tangible, non-transitory, machine-readable media storing instructions that, when executed by the one or more computers, perform the computer-implemented method/the computer-readable instructions stored on the non-transitory, computer-readable medium.

The subject matter described in this specification can be implemented to realize one or more of the following advantages. The described optical device provides an active laser detection system. Upon a detection of incoming laser radiation and specific retroreflection equipment signatures, the optical device can immediately close an optical aperture (e.g., an objective lens on a weapon scope) to generate a reflection interference and provides a detection notification. The detection notification can be provided variety of haptic signals. Other real-time detection countermeasures can be activated, such as using an electrochromic film over an optical detector of a sensor unit to also block reflections of the incoming laser or plethora of diaphragm principles that can be employed (from photographic shutters, to mechanical or electronic shutters). False detections are minimized while maintaining an ultra-fast response time (e.g., less than 50 milliseconds). The optical device attaches to any scope via a universal and secure coupler attaching the optical device to a variety of scopes objective facilitating integration into a variety of optical systems providing high compatibility and versatility.

The details of one or more implementations of the subject matter of this specification are set forth in the Detailed Description, the Claims, and the accompanying drawings. Other features, aspects, and advantages of the subject matter will become apparent to those of ordinary skill in the art from the Detailed Description, the Claims, and the accompanying drawings.

### DESCRIPTION OF DRAWINGS

FIG. 1A is a diagram of an example optical detection countermeasure system, according to some implementations of the present disclosure.

FIG. 1B is a block diagram of an example optical detection countermeasure system, according to some implementations of the present disclosure.

FIG. 2A is an illustration of an example assembly including an optical device attached to an optical target, according to an implementation of the present disclosure.

FIG. 2B is an illustration of an example optical device with a closing optical aperture cover, according to an implementation of the present disclosure.

FIG. 3A is a front perspective view of an example optical device with closed aperture cover, according to an implementation of the present disclosure.

FIG. 3B is a back perspective view of an example optical device with closed aperture cover, according to an implementation of the present disclosure.

FIG. 3C is a side view of an example optical device with closed aperture cover, according to an implementation of the present disclosure.

FIG. 3D is another side view of an example optical device with closed aperture cover, according to an implementation of the present disclosure.

FIG. 3E is a top view of an example optical device with closed aperture cover, according to an implementation of the present disclosure.

FIG. 3F is a bottom view of an example optical device with closed aperture cover, according to an implementation of the present disclosure.

FIG. 3G is a front perspective view of an example optical device with opened aperture, according to an implementation of the present disclosure.

FIG. 4 is a flowchart illustrating an example of a computer-implemented method for an optical detection countermeasure protocol, according to an implementation of the present disclosure.

FIG. 5 is a block diagram illustrating an example of a computer-implemented system used to provide computational functionalities associated with described algorithms, methods, functions, processes, flows, and procedures, according to an implementation of the present disclosure.

Like reference numbers and designations in the various drawings indicate like elements.

### DETAILED DESCRIPTION

The following detailed description describes an optical detection countermeasure protocol and is presented to enable any person skilled in the art to make and use the disclosed subject matter in the context of one or more particular implementations. The optical detection countermeasure protocol is executed using an optical device includes an ocular lens assembly, a sensor unit, and a processor. The ocular lens assembly captures and focuses a laser beam encoding an optical signature. The sensor unit is optically coupled to the ocular lens assembly and includes a laser beam detector detecting a light (e.g., laser) scanning event and decoding the optical signature to generate a decoded optical signature to identify a risk of the scanning event. The processor processes the decoded optical signature for selectively triggering a closure of an optical aperture.

Basic laser range finders (LRFs) use reflection from the target to compute distance. Particular “optical detectors” use the same principal LRF, and in addition look at features of “reflecting optical trains” or “optical retroreflection.” The optical retroreflection features facilitate the described systems to discriminate against normal reflections (e.g., produced by passive environmental elements, such as trees, or stones or buildings and people and) to specifically detect “optical devices” that are pointed towards an optical target and associated optical device. Retroreflection is a phenomenon that occurs as a consequence of active illumination. The retroreflection effect, commonly known as the “cat-eye” effect, is characterized by the reflection of light directly back towards its source, regardless of the viewing angle. Retroreflection is widely utilized in various applications where high visibility is crucial, particularly in low-light conditions. Range finders, in particular, gain significant advantages from the use of retroreflection. For example, by reflecting light directly back to the source, retroreflective materials, such as an objective lens of a rifle scope, facilitate range finders to accurately measure distances. A closure or coverage of an optical aperture (e.g., of a rifle scope) can disrupt the retroreflection preventing overall detection of the target and range finders from estimating the distance to the target, increasing the safety of the target.

Described is an approach for an optical detection countermeasure protocol that permits retroreflection disruption for target security. The described optical device features an advanced active laser detection system. The device utilizes a high-precision optical detector and a fast-acting cover closure to immediately close an optical aperture in response to detecting incoming optical (laser) radiation with a particular light beam signature. The optical aperture closure generates reflection interference and triggers a detection notification. The notification is delivered as a haptic signal, which also activates other real-time detection countermeasures. To ensure reliability, the optical device incorporates signal processors configured to process incoming light beams and differentiate light beam signatures to minimize false detections while maintaining an ultra-fast response time (e.g., less than 50 milliseconds). The optical device is designed with a universal and secure coupler, facilitating attachment to a variety of scope objective bells or mounts. As an additional advantage, the optical device can be communicatively coupled to a network system, providing high integration versatility and adaptability for different applications, further enhancing target security.

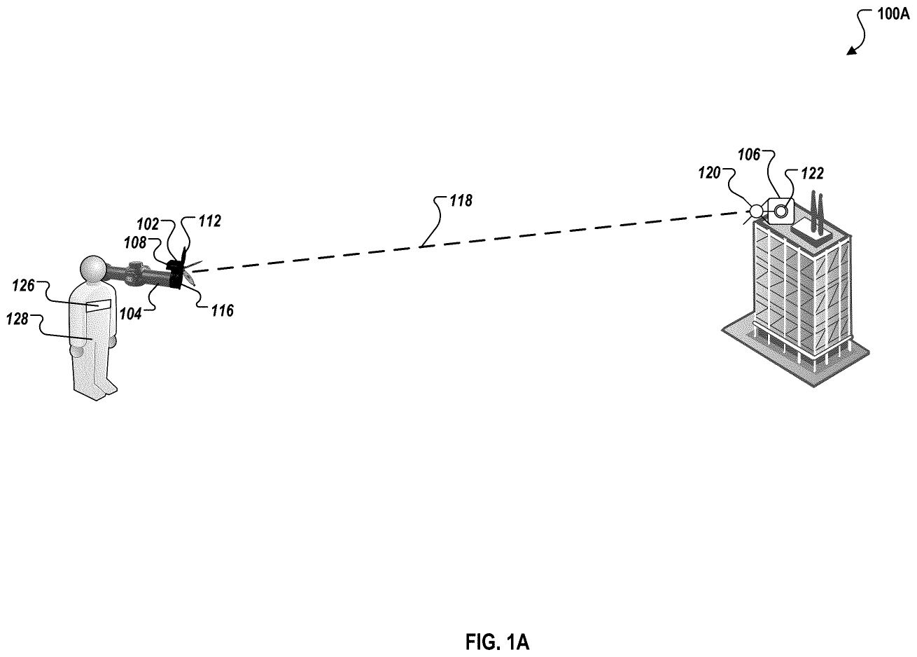

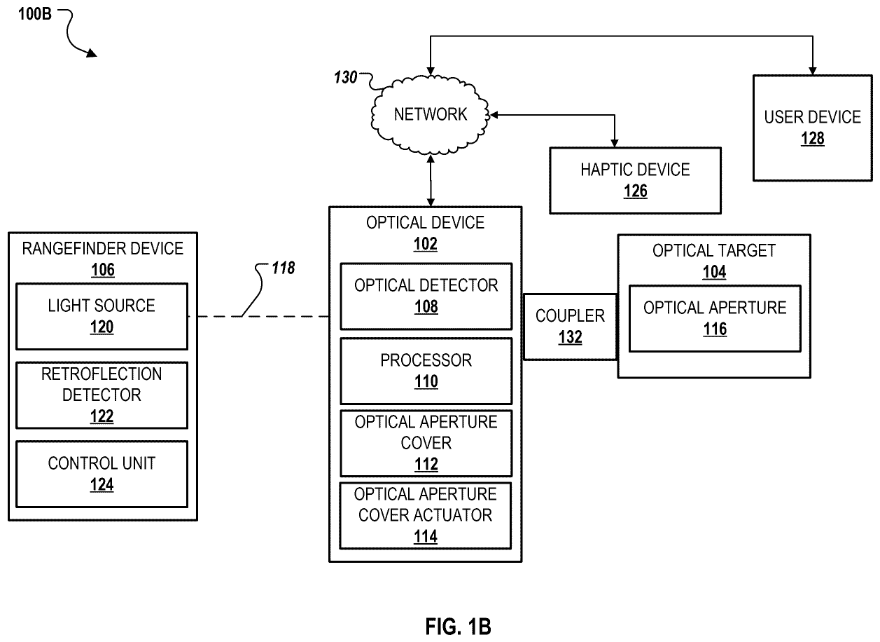

FIG. 1A is a diagram of an example optical detection countermeasure system 100A, according to some implementations of the present disclosure. The example optical detection countermeasure system 100A illustrates an example scenario of usage of the example optical detection countermeasure system 100A. FIG. 1B is a block diagram of an example optical detection countermeasure system 100B, according to some implementations of the present disclosure. The example optical detection countermeasure system 100B shows components of the example optical detection countermeasure system 100A.

The example optical detection countermeasure system 100A includes an optical device 102, an optical target 104, and a rangefinder device 106. As shown in FIGS. 1A and 1B, the optical device 102 can include an optical detector 108, a processor 110, an optical aperture cover 112, and an optical aperture cover actuator 114. The optical target 104 includes an optical aperture 116 (e.g., a reflection source or objective lens) that can be targeted by a light beam 118.

The optical detector 108 includes lens for light focusing and directing along an optical path towards sensors that can detect laser light or a light beam 118 in one or more of the mid-wave infrared (MWIR) band, broadband thermal, near-infrared (NIR), short-wave infrared (SWIR), and visible light spectrums. In some implementations, the optical detector 108 can include photodiodes that convert light into electrical current. The photodiodes can include different materials to cover various spectral ranges, such as silicon photodiodes facilitating visible and near-infrared (NIR) light detection, InGaAs photodiodes suitable for short-wave infrared (SWIR) detection, HgCdTe (MCT) photodiodes used for mid-wave infrared (MWIR) and long-wave infrared (LWIR) detection. The optical detector 108 can include avalanche photodiodes (APDs) that are highly sensitive photodiodes that operate with a high reverse bias, providing internal gain, being used for detecting low levels of light across visible, NIR, and SWIR ranges. The optical detector 108 can include photomultiplier tubes (PMTs) that can detect very low levels of light. PMTs are used in applications requiring high sensitivity across ultraviolet (UV), visible, and NIR ranges. The optical detector 108 can include charge-coupled devices (CCDs) and complementary metal-oxide-semiconductor (CMOS) sensors that are commonly used in imaging applications and can detect light across the visible spectrum. Specialized versions can also detect NIR light. The optical detector 108 can include thermal detectors that include bolometers and pyroelectric detectors, which can detect infrared radiation by measuring the heat generated by absorbed light. They are used for broadband thermal detection, covering MWIR and LWIR ranges. The optical detector 108 can include quantum dot detectors that can be tuned to detect specific wavelengths across a broad range, including visible, NIR, and SWIR.

The processor 110 included in the optical device 102 can be a central processing unit (CPU), an application specific integrated circuit (ASIC), a field-programmable gate array (FPGA), or another suitable component. The processor 110 executes instructions based on data received from the optical detector 108 to perform the operations activating the optical aperture cover 112, interfering with retroflection detection. Specifically, the processor 110 executes the functionality required to identify a light source 120 based on a signature of the light beam 118 to differentiate between team and unfriendly distance scanning of the rangefinder device 106. The processor 110 executes the functionality required to activate the optical aperture cover 112 to cover the optical aperture of the optical target 104, to prevent the rangefinder device 106 from determining the distance between the rangefinder device 106 and the optical target 104.

The optical aperture cover 112 can include a lens cover that is designed to be completely opaque. The optical aperture cover 112 can include a Material that is typically made from materials that have high opacity, such as metals (e.g., aluminum, steel) or certain plastics (e.g., polycarbonate, ABS). The materials used for the optical aperture cover 112 are chosen for their ability to block all light transmission. The optical aperture cover 112 can include a surface coating that can have a matte or non-reflective coating to prevent any light from reflecting off its surface to avoid any stray light that could potentially return to the rangefinder device 106. The thickness of the cover is usually thick enough to ensure that no light can pass through, even if the material itself is inherently opaque, to adds an extra layer of assurance against light penetration and reflection. The optical aperture cover 112 can fit the shape and dimension of the optical aperture 116 and can include a seal that is designed to fit snugly over the lens, creating a light-tight seal, to prevent any light from leaking through gaps or seams around the edges of the cover. The optical aperture cover 112 can be built to withstand environmental factors such as dust, moisture, and mechanical impact to ensures that the cover remains effective in blocking light under various conditions. In some implementations, the optical aperture cover 112 includes magnetic attachments to decrease a time of closing the optical aperture 116.

The rangefinder device 106 includes a light source 120, a retroflection detector 122, and a control unit 124. The light source 120 can include a laser diode or LED that emits the light beam 118. The light source 120 can generate infrared (IR) or visible light (e.g., 750 nm to 1700 nm), having a field-of-transmission, which can vary depending on the resolution and light detecting capability of retroflection detector 122 (e.g., optics and/or detectors). The light source 120 can generate light beam 118 with a particular optical signature at a set frequency sequence, wavelength, and transmission power. The light source 120 can have an adjustable focus that facilitates transition between a wide flood beam for close-range illumination and a narrow spot beam for long-range targeting (e.g., from 100 m to 4,000 m). The retroflection detector 122 can include a receiver (detector) that detects the reflected light beam that returns from the optical aperture 116 of the optical target 104. The retroflection detector 122 can be a photodiode, avalanche photodiode (APD), or other types of optical detectors suitable for the particular wavelength used by the light source 120. The control unit 124 can include a timing circuit that measures the time it takes for the light beam 118 to travel to the target and back. The control unit 124 can use the time-of-flight (TOF) measurement to calculate the distance between the rangefinder device 106 and the optical target 104. The control unit 124 can include a signal processor that processes the signals received from the retroflection detector 122 and calculates the distance based on the timing information. The control unit 124 can also execute algorithms to filter out noise and trigger operations in response to determining the distance between the rangefinder device 106 and the optical target 104. The rangefinder device 106 can be mounted on a building (as shown in FIG. 1A), on helmets of users, on weapons, on optical devices or on any combination thereof.

The optical device 102 can be mounted, using a coupler 132, on (on top or on a lateral side) of the optical target 104, such that the optical aperture cover 112 can be activated to cover an optical aperture 116 of the optical target 104 in response to the optical device 102 detecting an incoming light beam 118 generated by the light source 120 of the rangefinder device 106. The processor 110 can also generate a trigger to activate a haptic device 126 to generate a warning vibration for a user 128. In some implementations, the haptic device 126 is attached to the optical target 104 such that a user of the optical target can perceive a (e.g., 20 to 300 Hz) vibration generated by the haptic device 126. The frequency at which the vibration is generated by the haptic device 126 can also encode a message for the user, such that low frequencies (e.g., 20-50 Hz) can be indicative of a low risk, mid frequencies (e.g., 50 -150 Hz) can be indicative of a low risk, and high frequencies (e.g., 150-300 Hz) can be indicative of an immediate high risk. The processor 110 can transmit to a user device 128, via a network 130, an alert indicating the detection of the light beam 118. The optical device 102 can have a size of approximately 75×75×50 mm.

In general, the user device 128, shown in FIG. 1B, includes an electronic computer device operable to receive, transmit, process, and store any appropriate data associated with the optical device 102 of FIGS. 1A and 1B. The user device 128 is intended to encompass any client computing device such as a laptop/notebook computer, wireless data port, smart phone, personal data assistant (PDA), tablet computing device, one or more processors within these devices, or any other suitable processing device. The user device 128 includes an interface, a processor, a memory, and a GUIs. The user device 128 can include one or more applications including a service providing access to security countermeasures. In some instances, user device 128 can be associated with an agent supporting the safety of the user of the optical target 104 coupled to the optical device 102.

In some implementations, the network 130, shown in FIG. 1B, can include a large computer network, such as a local area network (LAN), a wide area network (WAN), the Internet, a cellular network, a telephone network (e.g., PSTN) or an appropriate combination thereof connecting any number of communication devices, mobile computing devices, fixed computing devices and server systems. Data exchanged over the network 130, is transferred using any number of network layer protocols, such as Internet Protocol (IP), Multiprotocol Label Switching (MPLS), Asynchronous Transfer Mode (ATM), Frame Relay, etc. Furthermore, in implementations where the network 130 represents a combination of multiple sub-networks, different network layer protocols are used at each of the underlying sub-networks. In some implementations, the network 130 represents one or more interconnected internetworks, such as the public Internet.

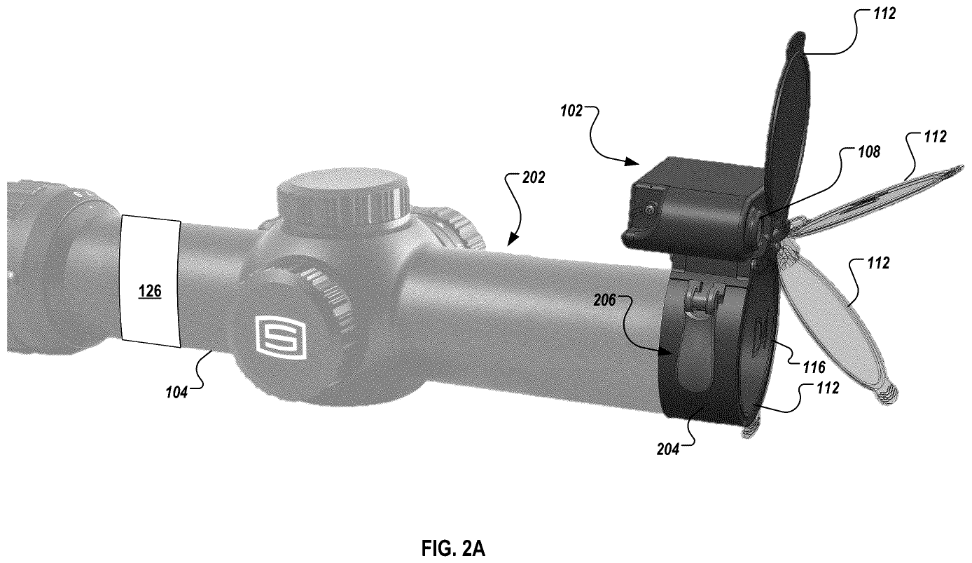

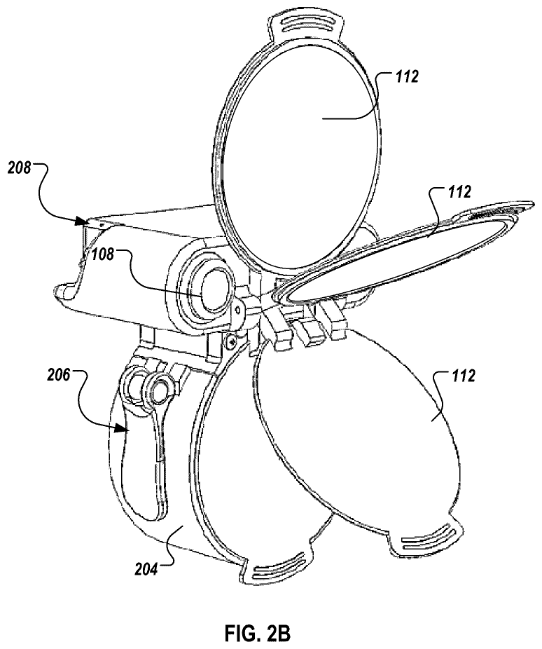

FIG. 2A is an illustration of an example assembly 200A including an optical device 102 attached to an optical target 104, according to an implementation of the present disclosure. The optical target 104 can include a riffle scope, a binocular, a spotting scope, or a telescope. The optical target 104 can include an optical sight tube 202 having an optical aperture 116, such as an objective lens, facing the rangefinder device (as shown in FIGS. 1A and 1B). In some implementations, the optical target 104 can include the coupler 132 (e.g., a linking feature) for facilitating attachment to the example optical device 102.

FIG. 2B is an illustration of an example optical device 102 with a closing optical aperture cover 112, according to an implementation of the present disclosure. As shown in both FIGS. 2A and 2B, the example optical device 102 includes a receiver portion 204, matching a shape and a size of an end of the optical sight tube 202, such that the optical sight tube 202 can slide within the receiver portion 204. The receiver portion 204 can include a locking mechanism 206 for locking the receiver portion 204 in terminal position. The locking mechanisms 206 can include a Rusan® mount for scopes, a locking pin, spring-loaded balls, or snapping devices of other locking types. The locking mechanisms 206 can be adjusted to link to the coupler 132 to interconnect the optical target 104 to the example optical device 102 in a secure configuration.

The optical device 102 includes a body 208 adjacent to the receiver portion 204. The body 208 can house the optical detector 108, the processor 110, the optical aperture cover 112 and an optical aperture cover actuator 114. The aperture cover actuator 114 can actuate a motorized mechanism to adjust a position of the optical aperture cover 112 to cover or open the optical aperture 116. For example, in response to detecting an incoming light beam, the optical aperture cover actuator 114 can lower the optical aperture cover 112 to cover the optical aperture 116. In the example of FIGS. 2A and 2B, the optical detector 108.

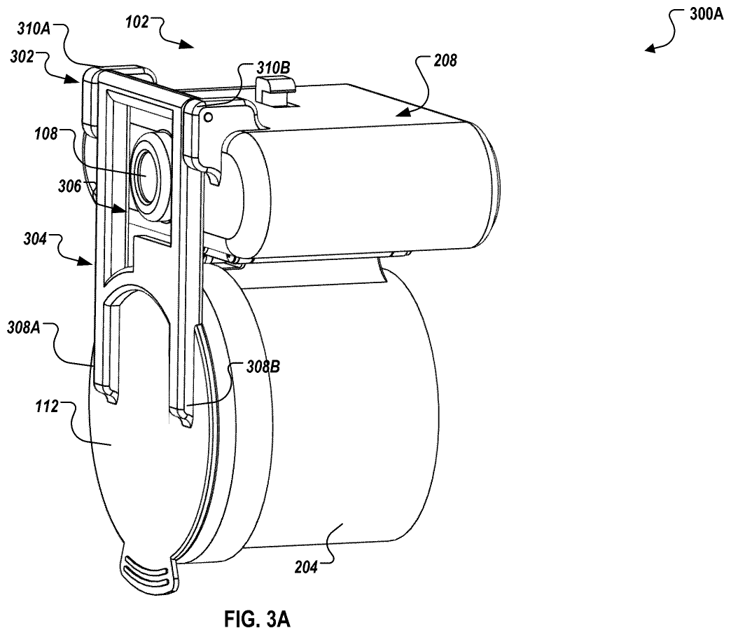

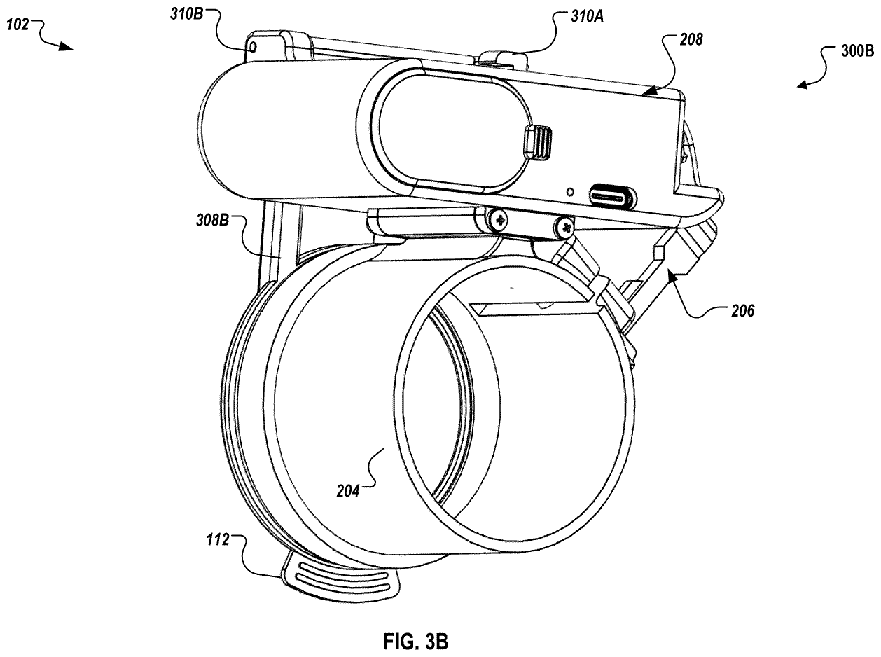

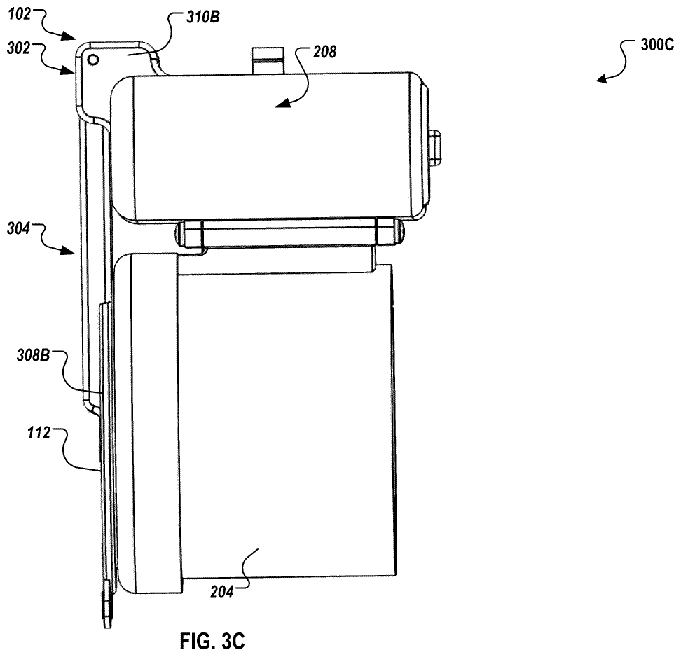

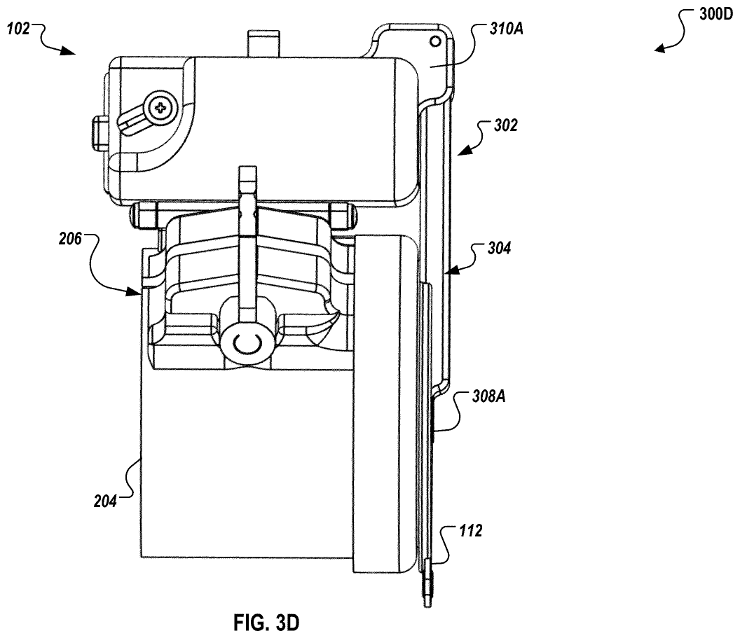

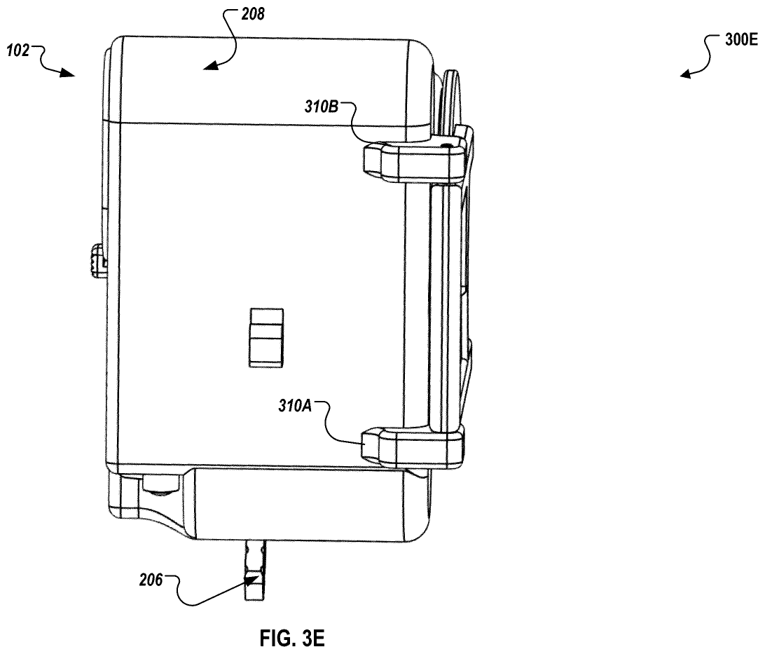

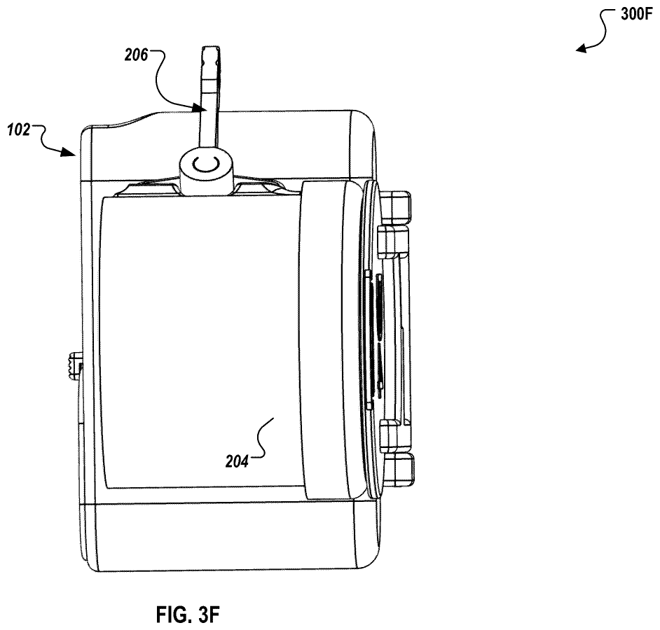

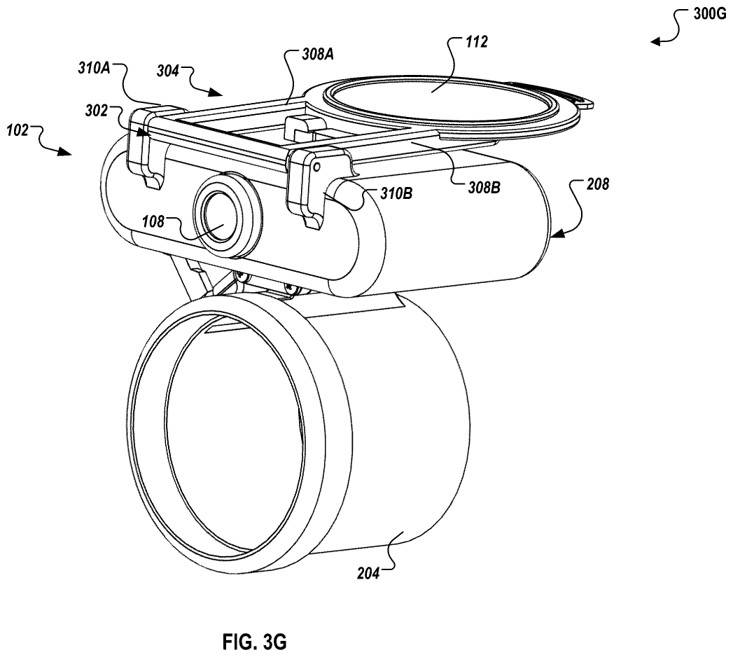

FIG. 3A is a front perspective view 300A of an example optical device 102 with closed aperture cover, according to an implementation of the present disclosure. FIG. 3B is a back perspective view 300B of an example optical device 102 with closed aperture cover, according to an implementation of the present disclosure. FIG. 3C is a side view 300C of an example optical device 102 with closed aperture cover, according to an implementation of the present disclosure. FIG. 3D is another side view 300D of an example optical device 102 with closed aperture cover, according to an implementation of the present disclosure. FIG. 3E is a top view 300E of an example optical device 102 with closed aperture cover, according to an implementation of the present disclosure. FIG. 3F is a bottom view 300F of an example optical device 102 with closed aperture cover, according to an implementation of the present disclosure. FIG. 3G is a front perspective view 300G of an example optical device 102 with opened aperture cover, according to an implementation of the present disclosure.

As shown in FIGS. 3A-3F, the optical aperture cover 112 can be attached to an actuator 302 attached to the body 208 of the optical device 102. The actuator 302 can include a rectangular frame 304, forming an opening 306 surrounding the optical detector 108 in the closed configuration (as shown in FIGS. 3A-3F). The rectangular frame 304 forms two arms 308A, 308B providing bilateral support to the optical aperture cover 112. The actuator 302 includes a pair of joints 310A, 310B facilitating a rotation of the arms 308A, 308B from a closed position (as shown in FIGS. 3A-3F), in which the optical aperture is completely covered to an opened position (as shown in FIG. 3G), in which the optical aperture is completely opened. The rectangular frame 304 provides the advantage of maximizing exposure of the optical detector 108 to incoming light beams in all configurations, including during the transition period from the closed position (as shown in FIGS. 3A-3F) to the opened position (as shown in FIG. 3G).

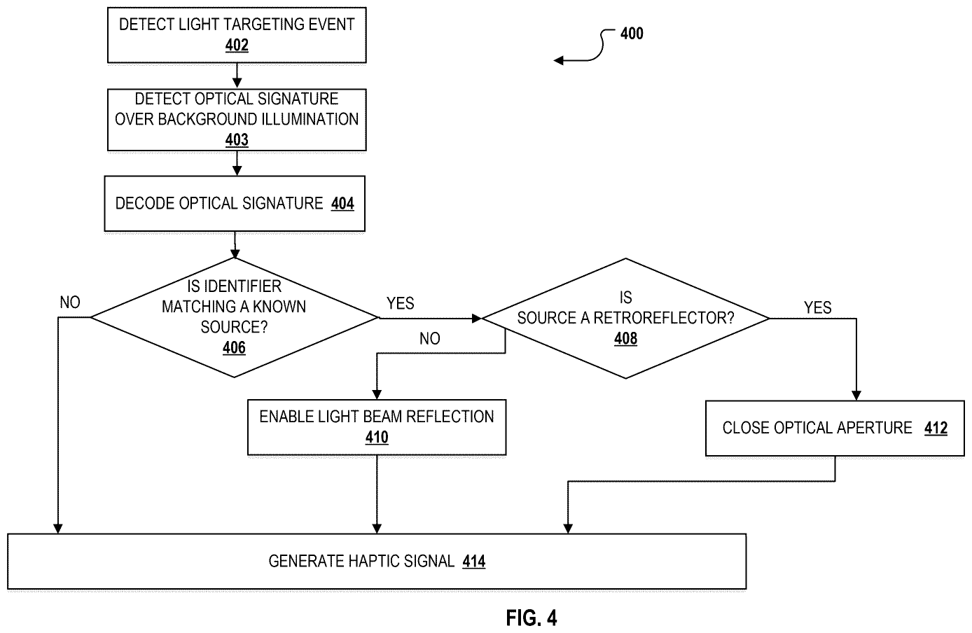

FIG. 4 is a flowchart illustrating an example of a computer-implemented method 400 for providing a smart beacon video-based communication protocol, according to an implementation of the present disclosure. For clarity of presentation, the description that follows generally describes method 400 in the context of the other figures in this description. However, it will be understood that method 400 can be performed, for example, by any system, environment, software, and hardware, or a combination of systems, environments, software, and hardware, as appropriate. In some implementations, various steps of method 400 can be run in parallel, in combination, in loops, or in any order.

At 402, a light targeting event including an identification of a light beam focused on an optical target is detected. The light beam can encode an optical signature defined by a particular frequency modulation. The frequency modulation can define a sequence of light pulses emitted at particular frame rates that represent an identifier of a rangefinder device including the light source that generated the light beam. In some implementations, the light is mid-wave (MW) infrared (IR), broadband thermal, near-IR (NIR), short-wave IR (SWIR), or visible light spectrum (e.g., having a wavelength from substantially 750 nm to substantially 1700 nm).

At 403, the signal is filtered to separate an optical signature from background illumination. The filtering process can include application of modulation techniques to modulate the signal at a particular frequency and use a lock-in amplifier to detect the modulated signal that distinguishes the signal from the background noise. The filtering process can include execution of image processing algorithms that apply image processing techniques such as background subtraction, thresholding, and filtering to enhance the optical signature and reduce background noise.

At 404, the optical signature is decoded to generate a decoded optical signature. Decoding can include converting the optical signal into an electrical signal, demodulating the electrical signal (to identify shifts in the signal frequency) and matching the demodulated signal to a list of signatures to determine an identifier of a source of the light beam and to determine a target action (e.g., friendly action or expected threat) of a user of the source of the light beam.

At 406, it is determined whether the identifier of the source of the light beam matches an identifier of a team source. For example, the user can be associated with a team of users of rangefinder devices, each having a particular identifier classified as a team source. A team source is defined as a low or nonexistent risk rangefinder device.

At 408, in response to determining that the identifier of the source of the light beam matches an identifier of a team source, it is determined whether the source of the light beam is a retroflector.

At 410, in response to determining that the source of the light beam is different from a retroflector, being for example a team member light source device, a verification of an opening state of the optical aperture of the optical target is generated to facilitate intercommunication between team members using light beam transmission encoded with particular signatures.

At 412, in response to determining that the source of the light beam is a retroflector, a trigger to close the optical aperture of the optical target is generated. Closing the optical aperture of the optical target includes actuating a movement of a frame supporting an optical aperture cover for closure of the optical aperture of the optical target.

At 414, a haptic signal indicative of detecting the light targeting event and the associated identified risk is generated. In some implementations, an alert indicative of the light targeting event and the associated identified risk is generated and transmitted for display on a user interface of a user device. In some implementations, the detection and decoding is performed at least twice to ensure risk estimation accuracy. The example process 400 can be completed in less than 50 milliseconds for providing a timely reaction and response to the detected light targeting event that facilitates a safety of the user of the optical target.

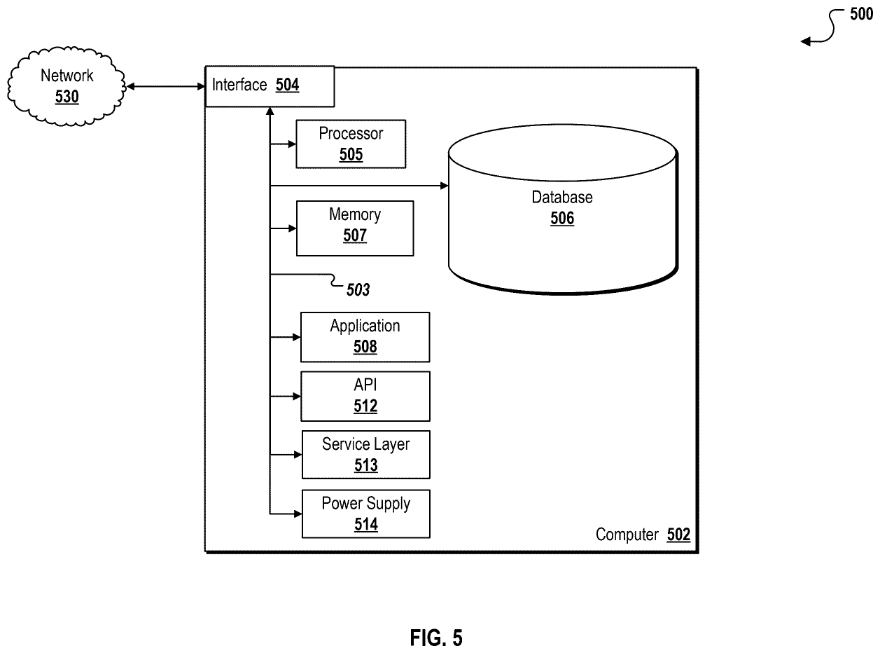

FIG. 5 is a block diagram illustrating an example of a computer-implemented System 500 used to provide computational functionalities associated with described algorithms, methods, functions, processes, flows, and procedures, according to an implementation of the present disclosure. In the illustrated implementation, computer-implemented system 500 includes a Computer 502 and a Network 530.

The illustrated Computer 502 is intended to encompass any computing device, such as a server, desktop computer, laptop/notebook computer, wireless data port, smart phone, personal data assistant (PDA), tablet computer, one or more processors within these devices, or a combination of computing devices, including physical or virtual instances of the computing device, or a combination of physical or virtual instances of the computing device. Additionally, the Computer 502 can include an input device, such as a keypad, keyboard, or touch screen, or a combination of input devices that can accept user information, and an output device that conveys information associated with the operation of the Computer 502, including digital data, visual, audio, another type of information, or a combination of types of information, on a graphical-type user interface (UI) (or GUI) or other UI.

The Computer 502 can serve in a role in a distributed computing system as, for example, a client, network component, a server, or a database or another persistency, or a combination of roles for performing the subject matter described in the present disclosure. The illustrated Computer 502 is communicably coupled with a Network 530. In some implementations, one or more components of the Computer 502 can be configured to operate within an environment, or a combination of environments, including cloud-computing, local, or global.

At a high level, the Computer 502 is an electronic computing device operable to receive, transmit, process, store, or manage data and information associated with the described subject matter. According to some implementations, the Computer 502 can also include or be communicably coupled with a server, such as an application server, e-mail server, web server, caching server, or streaming data server, or a combination of servers.

The Computer 502 can receive requests over Network 530 (for example, from a client software application executing on another Computer 502) and respond to the received requests by processing the received requests using a software application or a combination of software applications. In addition, requests can also be sent to the Computer 502 from internal users (for example, from a command console or by another internal access method), external or third-parties, or other entities, individuals, systems, or computers.

Each of the components of the Computer 502 can communicate using a System Bus 503. In some implementations, any or all of the components of the Computer 502, including hardware, software, or a combination of hardware and software, can interface over the System Bus 503 using an application programming interface (API) 512, a Service Layer 513, or a combination of the API 512 and Service Layer 513. The API 512 can include specifications for routines, data structures, and object classes. The API 512 can be either computer-language independent or dependent and refer to a complete interface, a single function, or even a set of APIs. The Service Layer 513 provides software services to the Computer 502 or other components (whether illustrated or not) that are communicably coupled to the Computer 502. The functionality of the Computer 502 can be accessible for all service consumers using the Service Layer 513. Software services, such as those provided by the Service Layer 513, provide reusable, defined functionalities through a defined interface. For example, the interface can be software written in a computing language (for example JAVA or C++) or a combination of computing languages, and providing data in a particular format (for example, extensible markup language (XML)) or a combination of formats. While illustrated as an integrated component of the Computer 502, alternative implementations can illustrate the API 512 or the Service Layer 513 as stand-alone components in relation to other components of the Computer 502 or other components (whether illustrated or not) that are communicably coupled to the Computer 502. Moreover, any or all parts of the API 512 or the Service Layer 513 can be implemented as a child or a sub-module of another software module, enterprise application, or hardware module without departing from the scope of the present disclosure.

The Computer 502 includes an Interface 504. Although illustrated as a single Interface 504, two or more Interfaces 504 can be used according to particular needs, desires, or particular implementations of the Computer 502. The Interface 504 is used by the Computer 502 for communicating with another computing system (whether illustrated or not) that is communicatively linked to the Network 530 in a distributed environment. Generally, the Interface 504 is operable to communicate with the Network 530 and includes logic encoded in software, hardware, or a combination of software and hardware. More specifically, the Interface 504 can include software supporting one or more communication protocols associated with communications such that the Network 530 or hardware of Interface 504 is operable to communicate physical signals within and outside of the illustrated Computer 502.

The Computer 502 includes a Processor 505. Although illustrated as a single Processor 505, two or more Processors 505 can be used according to particular needs, desires, or particular implementations of the Computer 502. Generally, the Processor 505 executes instructions and manipulates data to perform the operations of the Computer 502 and any algorithms, methods, functions, processes, flows, and procedures as described in the present disclosure.

The Computer 502 also includes a Database 506 that can hold data for the Computer 502, another component communicatively linked to the Network 530 (whether illustrated or not), or a combination of the Computer 502 and another component. For example, Database 506 can be an in-memory or conventional database storing data consistent with the present disclosure. In some implementations, Database 506 can be a combination of two or more different database types (for example, a hybrid in-memory and conventional database) according to particular needs, desires, or particular implementations of the Computer 502 and the described functionality. Although illustrated as a single Database 506, two or more databases of similar or differing types can be used according to particular needs, desires, or particular implementations of the Computer 502 and the described functionality. While Database 506 is illustrated as an integral component of the Computer 502, in alternative implementations, Database 506 can be external to the Computer 502. The Database 506 can hold and operate on at least any data type mentioned or any data type consistent with this disclosure.

The Computer 502 also includes a Memory 507 that can hold data for the Computer 502, another component or components communicatively linked to the Network 530 (whether illustrated or not), or a combination of the Computer 502 and another component. Memory 507 can store any data consistent with the present disclosure. In some implementations, Memory 507 can be a combination of two or more different types of memory (for example, a combination of semiconductor and magnetic storage) according to particular needs, desires, or particular implementations of the Computer 502 and the described functionality. Although illustrated as a single Memory 507, two or more Memories 507 or similar or differing types can be used according to particular needs, desires, or particular implementations of the Computer 502 and the described functionality. While Memory 507 is illustrated as an integral component of the Computer 502, in alternative implementations, Memory 507 can be external to the Computer 502.

The Application 508 is an algorithmic software engine providing functionality according to particular needs, desires, or particular implementations of the Computer 502, particularly with respect to functionality described in the present disclosure. For example, Application 508 can serve as one or more components, modules, or applications. Further, although illustrated as a single Application 508, the Application 508 can be implemented as multiple Applications 508 on the Computer 502. In addition, although illustrated as integral to the Computer 502, in alternative implementations, the Application 508 can be external to the Computer 502.

The Computer 502 can also include a Power Supply 514. The Power Supply 514 can include a rechargeable or non-rechargeable battery that can be configured to be either user- or non-user-replaceable. In some implementations, the Power Supply 514 can include power-conversion or management circuits (including recharging, standby, or another power management functionality). In some implementations, the Power Supply 514 can include a power plug to allow the Computer 502 to be plugged into a wall socket or another power source to, for example, power the Computer 502 or recharge a rechargeable battery.

There can be any number of Computers 502 associated with, or external to, a computer system containing Computer 502, each Computer 502 communicating over Network 530. Further, the term “client,” “user,” or other appropriate terminology can be used interchangeably, as appropriate, without departing from the scope of the present disclosure. Moreover, the present disclosure contemplates that many users can use one Computer 502, or that one user can use multiple computers 502.

Described implementations of the subject matter can include one or more features, alone or in combination.

For example, in a first implementation, a computer-implemented method, comprising: receiving, by a smart beacon video processor and from a digital video camera, digital video data including light from a smart beacon; processing, by the smart beacon video processor, the digital video data to determine a smart beacon pixel location; analyzing, by the smart beacon video processor, the smart beacon pixel location; determining, by the smart beacon video processor and as determined blank video frames, blank video frames associated with the smart beacon pixel location; and decoding, by the smart beacon video processor and as message data, the determined blank video frames.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs, that is, one or more modules of computer program instructions encoded on a tangible, non-transitory, computer-readable medium for execution by, or to control the operation of, a computer or computer-implemented system. Alternatively, or additionally, the program instructions can be encoded in/on an artificially generated propagated signal, for example, a machine-generated electrical, optical, or electromagnetic signal that is generated to encode information for transmission to a receiver apparatus for execution by a computer or computer-implemented system. The computer-storage medium can be a machine-readable storage device, a machine-readable storage substrate, a random or serial access memory device, or a combination of computer-storage mediums. Configuring one or more computers means that the one or more computers have installed hardware, firmware, or software (or combinations of hardware, firmware, and software) so that when the software is executed by the one or more computers, particular computing operations are performed. The computer storage medium is not, however, a propagated signal.

The term “real-time,” “real time,” “realtime,” “real (fast) time (RFT),” “near(ly) real-time (NRT),” “quasi real-time,” or similar terms (as understood by one of ordinary skill in the art), means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second(s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

The terms “data processing apparatus,” “computer,” “computing device,” or “electronic computer device” (or an equivalent term as understood by one of ordinary skill in the art) refer to data processing hardware and encompass all kinds of apparatuses, devices, and machines for processing data, including by way of example, a programmable processor, a computer, or multiple processors or computers. The computer can also be, or further include special-purpose logic circuitry, for example, a central processing unit (CPU), a field-programmable gate array (FPGA), or an application-specific integrated circuit (ASIC). In some implementations, the computer or computer-implemented system or special-purpose logic circuitry (or a combination of the computer or computer-implemented system and special-purpose logic circuitry) can be hardware-or software-based (or a combination of both hardware-and software-based). The computer can optionally include code that creates an execution environment for computer programs, for example, code that constitutes processor firmware, a protocol stack, a database management system, an operating system, or a combination of execution environments. The present disclosure contemplates the use of a computer or computer-implemented system with an operating system, for example LINUX, UNIX, WINDOWS, MAC OS, ANDROID, or IOS, or a combination of operating systems.

A computer program, which can also be referred to or described as a program, software, a software application, a unit, a module, a software module, a script, code, or other component can be written in any form of programming language, including compiled or interpreted languages, or declarative or procedural languages, and it can be deployed in any form, including, for example, as a stand-alone program, module, component, or subroutine, for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files, for example, files that store one or more modules, sub-programs, or portions of code. A computer program can be deployed to be executed on one computer or on multiple computers that are located at one site or distributed across multiple sites and interconnected by a communication network.

While portions of the programs illustrated in the various figures can be illustrated as individual components, such as units or modules, that implement described features and functionality using various objects, methods, or other processes, the programs can instead include a number of sub-units, sub-modules, third-party services, components, libraries, and other components, as appropriate. Conversely, the features and functionality of various components can be combined into single components, as appropriate. Thresholds used to make computational determinations can be statically, dynamically, or both statically and dynamically determined.

Described methods, processes, or logic flows represent one or more examples of functionality consistent with the present disclosure and are not intended to limit the disclosure to the described or illustrated implementations, but to be accorded the widest scope consistent with described principles and features. The described methods, processes, or logic flows can be performed by one or more programmable computers executing one or more computer programs to perform functions by operating on input data and generating output data. The methods, processes, or logic flows can also be performed by, and computers can also be implemented as, special-purpose logic circuitry, for example, a CPU, an FPGA, or an ASIC.

Computers for the execution of a computer program can be based on general or special-purpose microprocessors, both, or another type of CPU. Generally, a CPU will receive instructions and data from and write to a memory. The essential elements of a computer are a CPU, for performing or executing instructions, and one or more memory devices for storing instructions and data. Generally, a computer will also include, or be operatively coupled to, receive data from or transfer data to, or both, one or more mass storage devices for storing data, for example, magnetic, magneto-optical disks, or optical disks. However, a computer need not have such devices. Moreover, a computer can be embedded in another device, for example, a mobile telephone, a personal digital assistant (PDA), a mobile audio or video player, a game console, a global positioning system (GPS) receiver, or a portable memory storage device, for example, a universal serial bus (USB) flash drive, to name just a few.

Non-transitory computer-readable media for storing computer program instructions and data can include all forms of permanent/non-permanent or volatile/non-volatile memory, media and memory devices, including by way of example semiconductor memory devices, for example, random access memory (RAM), read-only memory (ROM), phase change memory (PRAM), static random access memory (SRAM), dynamic random access memory (DRAM), erasable programmable read-only memory (EPROM), electrically erasable programmable read-only memory (EEPROM), and flash memory devices; magnetic devices, for example, tape, cartridges, cassettes, internal/removable disks; magneto-optical disks; and optical memory devices, for example, digital versatile/video disc (DVD), compact disc (CD)-ROM, DVD+/-R, DVD-RAM, DVD-ROM, high-definition/density (HD)-DVD, and BLU-RAY/BLU-RAY DISC (BD), and other optical memory technologies. The memory can store various objects or data, including caches, classes, frameworks, applications, modules, backup data, jobs, web pages, web page templates, data structures, database tables, repositories storing dynamic information, or other appropriate information including any parameters, variables, algorithms, instructions, rules, constraints, or references. Additionally, the memory can include other appropriate data, such as logs, policies, security or access data, or reporting files. The processor and the memory can be supplemented by, or incorporated in, special-purpose logic circuitry.

To provide for interaction with a user, implementations of the subject matter described in this specification can be implemented on a computer having a display device, for example, a cathode ray tube (CRT), liquid crystal display (LCD), light emitting diode (LED), or plasma monitor, for displaying information to the user and a keyboard and a pointing device, for example, a mouse, trackball, or trackpad by which the user can provide input to the computer. Input can also be provided to the computer using a touchscreen, such as a tablet computer surface with pressure sensitivity or a multi-touch screen using capacitive or electric sensing. Other types of devices can be used to interact with the user. For example, feedback provided to the user can be any form of sensory feedback (such as, visual, auditory, tactile, or a combination of feedback types). Input from the user can be received in any form, including acoustic, speech, or tactile input. In addition, a computer can interact with the user by sending documents to and receiving documents from a client computing device that is used by the user (for example, by sending web pages to a web browser on a user's mobile computing device in response to requests received from the web browser).

The term “graphical user interface (GUI) can be used in the singular or the plural to describe one or more graphical user interfaces and each of the displays of a particular graphical user interface. Therefore, a GUI can represent any graphical user interface, including but not limited to, a web browser, a touch screen, or a command line interface (CLI) that processes information and efficiently presents the information results to the user. In general, a GUI can include a number of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back-end component, for example, as a data server, or that includes a middleware component, for example, an application server, or that includes a front-end component, for example, a client computer having a graphical user interface or a Web browser through which a user can interact with an implementation of the subject matter described in this specification, or any combination of one or more such back-end, middleware, or front-end components. The components of the system can be interconnected by any form or medium of wireline or wireless digital data communication (or a combination of data communication), for example, a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11x or other protocols, all or a portion of the Internet, another communication network (such as direct laser communication), or a combination of communication networks. The communication network can communicate with, for example, Internet Protocol (IP) packets, frame relay frames, Asynchronous Transfer Mode (ATM) cells, voice, video, data, or other information between network nodes.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any inventive concept or on the scope of what can be claimed, but rather as descriptions of features that can be specific to particular implementations of particular inventive concepts. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features can be described as acting in certain combinations and even initially claimed as such, one or more features from a claimed combination can, in some cases, be excised from the combination, and the claimed combination can be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations can be considered optional), to achieve desirable results. In certain circumstances, multitasking or parallel processing (or a combination of multitasking and parallel processing) can be advantageous and performed as deemed appropriate.

The separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

What is claimed is:

1. An optical device comprising:
an optical detector for detecting a light beam focused on an optical target coupled to the optical device, the light beam encoding an optical signature;
a processor for decoding the optical signature of the light beam to generate a decoded optical signature, the processor comparing the decoded optical signature to a list of optical signature types to determine a target action of an optical source; and
an optical aperture cover reacting to the target action of an optical source by selectively closing an optical aperture of the optical target.

2. The optical device of claim 1, further comprising a body housing the processor and a receiver portion coupling to a portion of the optical target.

3. The optical device of claim 2, wherein the optical aperture cover actuator comprises joints attached to the body and a rectangular frame forming arms attached to the optical aperture cover.

4. The optical device of claim 1, wherein the optical detector comprises photodiodes, visible and short-wave infra-red (SWIR) sensors or long-wave infra-red (LWIR) sensors.

5. The optical device of claim 1, wherein the processor generates a haptic signal indicative of detecting the light beam being focused on the optical target.

6. The optical device of claim 1, wherein the processor processes the decoded optical signature to determine an identifier of a source of the light beam.

7. The optical device of claim 1, wherein the processor processes the decoded optical signature to differentiate between a target sniper event and team spotting.

8. The optical device of claim 1, wherein the optical target comprises a scope, a spotting scope, a telescope, or a binocular.

9. The optical device of claim 1, wherein the light beam comprises a mid-wave infrared light, broadband thermal, near-infrared light, short-wave infrared light, or visible light.

10. A computer-implemented method comprising:
detecting a light targeting event comprising identification of a light beam focused on an optical target, the light beam encoding an optical signature;
decoding the optical signature to generate a decoded optical signature; and
generating a trigger for controlling a movement of an optical aperture cover for closure of an optical aperture of the optical target.

11. The computer-implemented method of claim 10, further comprising:
generating a haptic signal indicative of detecting the light targeting event.

12. The computer-implemented method of claim 10, further comprising:
processing the decoded optical signature to determine an identifier of a source of the light beam.

13. The computer-implemented method of claim 10, further comprising:
processing the decoded optical signature to differentiate between a target sniper event and a team spotting event.

14. The computer-implemented method of claim 10, further comprising:
transmitting an alert to be displayed by a user device.

15. The computer-implemented method of claim 10, wherein the optical target comprises a scope, a spotting scope, a telescope, or a binocular.

16. A non-transitory, computer-readable medium storing one or more instructions executable by a computer system to perform operations, comprising:
detecting a light targeting event comprising identification of a light beam focused on an optical target, the light beam encoding an optical signature;
decoding the optical signature to generate a decoded optical signature; and
generating a trigger for controlling a movement of an optical aperture cover for closure of an optical aperture of the optical target.

17. The non-transitory, computer-readable medium of claim 16, wherein the operations comprise:
generating a haptic signal indicative of detecting the light targeting event.

18. The non-transitory, computer-readable medium of claim 16, wherein the operations comprise:
processing the decoded optical signature to determine an identifier of a source of the light beam.

19. The non-transitory, computer-readable medium of claim 16, wherein the operations comprise:
processing the decoded optical signature to differentiate between a target sniper event and a team spotting event.

20. The non-transitory, computer-readable medium of claim 16, wherein the operations comprise:
transmitting an alert to be displayed by a user device.
